(19) United States
(12) Patent Application Publication
(10) Pub. No.: US 2011/0187591 A1
(43) Pub. Date: Aug. 4, 2011

(54) HYBRID WIRELESS AREA NETWORK (WAN) AND GLOBAL POSITIONING SYSTEM (GPS) CIRCUIT BOARD AND METHOD FOR SEAMLESS INDOOR AND OUTDOOR TRACKING

(76) Inventor: Jonathan B. WALKER, SR., Rockville, MD (US)

(21) Appl. No.: 12/697,576

(22) Filed: Feb. 1, 2010

(51) Int. Cl. G01S 19/46

(52) U.S. Cl. 342/357.29

(57) ABSTRACT

Systems and methods for distance and location tracking a wireless device are disclosed. More specifically, according to one aspect of the present disclosure, a Wireless Area Network-Location Based Services (WAN-LBS) algorithm that utilizes a hybrid Wireless Area Network (WAN) and Global Positioning System (GPS) circuit board and method for seamless indoor and outdoor tracking is disclosed. The WAN-LBS algorithm, in conjunction with the hybrid WAN/GPS circuit board, optimizes the degrees of precision and accuracy for distance measurements in locating a fixed or mobile IEEE 802® device. In one embodiment, the hybrid WAN/GPS circuit board according to the present disclosure integrates the data of a GPS receiver and several IEEE 802 standards based receivers. In another embodiment, the WAN-LBS algorithm according to the present disclosure utilizes received data, acquired by the hybrid circuit board, to calculate distances to the tracking devices, seamlessly in both indoor and outdoor environments.

### BACKGROUND OF THE INVENTION

1. Field of the Invention

The present invention generally relates to the field of mobile positioning. More specifically, the present invention relates to systems and methods for wireless Location Based Services.

2. Description of Related Art

Cellular Networks, Global Positioning Systems (GPS) and wireless E911 services address the issue of location finding. However, these conventional technologies cannot provide an indoor geo-location because they have various electrical magnetic limitations (e.g., radio interference, penetration loss, and multipath conditions). A location finding system should be able to seamlessly use cellular, GPS, and WANs for tracking devices/users that roam between networks or among a variety of environments. Today, the most commercially recognized wireless location finding systems is comprised of GPS networks that were stimulated by the U.S. GPS Policy of 1996, which has several major goals: advancing U.S. scientific and technical capabilities; promoting safety and efficiency in transportation and other fields; encouraging private sector investment in and use of U.S. GPS technologies and services; strengthening and maintaining our national security; promoting international cooperation in using GPS for peaceful purposes; and encouraging acceptance and integration of GPS into peaceful civil, commercial and scientific applications worldwide.

Thus, the most obvious applications have been in the areas of advance U.S. scientific and technical capabilities by means of Global System for Mobile Communications (GSM) and Code Division Multiple Access (CDMA) in worldwide commercial applications such as transportation management, directional finding software, and emergency services. In cellular service there are two main competing network technologies: Global System for Mobile Communications (GSM) and Code Division Multiple Access (CDMA). Cellular carriers including Sprint PCS, Cingular Wireless, Verizon and T-Mobile use one or the other.

Compared to Wireless Local Area Network (WLAN) positioning, sensor networks have a longer history of research with a number of different frequency bands including ultrasound, infrared, and recently Ultra-Wideband. Key disadvantages of all of these conventional technologies are the coverage areas resulting from their corresponding frequencies. These technologies are all geared toward a very small region, commonly referred to as a Personal Area Network. With these conventional technologies, a higher concentration or a dense population of sensors is required, thereby increasing the cost of deploying a sensor network.

WLAN positioning has attracted attention in recent years because of the intense demand for large-scale indoor WLAN deployments, as well as outdoor citywide wireless deployments in the region of municipal wireless. Many signal processing techniques have been proposed for location estimation for 802.11 based wireless networks such as client-based design since signal strength measurement is part of the normal operating. However, a client-assisted location system draws resources from client terminals, access points, and sniffing devices to locate the clients in a WLAN.

Although the dual approach of combining multiple LBS technologies is starting to increase in popularity, there are very few commercial applications that utilize WLAN-LBS systems. Most WLAN-LBS products are software-based and are designed for outdoor applications. Conventionally, the data collection process for WLAN-LBS entails a crude method (often called “wardriving”) of walking, driving, or flying throughout a region of wireless access points with a laptop running WLAN detection software.

Thus, there are numerous Cellular and GPS tracking devices on the market today. Yet, the conventional receiving devices typically do not work indoors due to sensitivity levels. Overall, the challenges are intrinsic to the wireless environment. These problems include channel fading, low signal-to-noise ratios (SNRs), multi-user interference, and multipath conditions.

Furthermore, cellular tracking devices require a pre-existing infrastructure, which is primarily present in urban environments rather than rural areas. Thus, it is nearly impossible to track a device once the unit has exceeded the range of three (3) or more cellular towers; that is, the cellular tracking system cannot triangulate the mobile device. For military tracking devices in hostile military environments, mobile troops cannot erect fixed communication systems because the system will become a target for enemies. Moreover, the hostile military environment is often plagued with items that reduce signal strength, such as trees, bridges, concrete, and metal. Therefore, in such environments, it is often difficult to receive a satellite or GPS signal indoors or in a heavily forested environment.

### SUMMARY OF THE INVENTION

The hybrid WAN/GPS Circuit Board according to present invention provides solutions to the aforementioned problems observed in the conventional art. The advantages of the present invention include, but are not limited to, seamless indoor and outdoor tracking. The hybrid WAN/GPS circuit board tracks fixed or mobile devices that have embedded IEEE 802 technology, including 802.11™ (Wi-Fi®), 802.15™ (WPAN, Bluetooth, ZigBee), 802.16™ (WiMax), 802.20™ (MBWA), and/or 802.22™ (WRAN). The mobile device units can be located and tracked seamlessly from an outdoors to indoors environment (or vice versa). Another advantage of the present invention is the Wireless Area Network-Location Based Services (WAN-LBS) algorithm used to determine distance in conjunction with the disclosed hybrid WAN/GPS circuit board. The WAN-LBS algorithm has a higher degree of accuracy for indoor environments so that a wider range of applications can be supported.

Furthermore, the hybrid WAN/GPS circuit board according to the present invention has low computational overhead; the dual hardware and software approach decreases computational overhead, especially for a mobile device with energy-constraints. In addition, a beacon database is not required for the hybrid WAN/GPS circuit board according to the present invention; neither is a pre-scan of fixed wireless access points (WAPs) locations required. In contrast to the hybrid WAN/GPS circuit board according to the present invention, most conventional LBS algorithms require a collection of WLAN locations to be stored in a database beforehand and then downloaded onto a mobile device prior to tracking.

Moreover, the hybrid WAN/GPS circuit board according to the present invention does not require pre-existing wireless network infrastructure. In contrast, conventional Wi-Fi positioning systems for indoor tracking require a pre-existing wireless network comprising several WAPs throughout a building; this architecture utilizes the old cellular phone technique of triangulation and is not adaptable for rapidly moving environments or hostile military applications.

According to one aspect of the present invention, a method for seamless indoor and outdoor distance and preferably also location tracking of a wireless device using a hybrid wireless area network (WAN)/global positioning system (GPS) device is provided. The method includes receiving GPS and WAN data corresponding to the distance and preferably also location of the wireless device, which can also be considered in some situations as including sensing GPS and WAN signals and/or receiving GPS and WAN data using the wireless device; transmitting GPS and WAN data corresponding to the distance and preferably also location of the wireless device; amalgamating the received WAN and GPS data; segmenting the amalgamated data; optimizing distance and preferably also location measurements from transmitted radio frequency (RF) spectrum and modulation data; determining azimuth and elevation location using E-plane and H-plane radiation pattern of the hybrid WAN/GPS device; and applying one or more approximation algorithms to the GPS and WAN data to obtain the distance and preferably also location of the wireless device; and outputting the distance and preferably also location of the wireless device.

In another aspect of the present invention, a system for seamless indoor and outdoor distance and measuring tracking of a wireless device is provided. The system includes the wireless device and a hybrid wireless area network (WAN)/global positioning system (GPS) circuit board. The circuit board includes a GPS device that receives and transmits GPS data corresponding to the distance and preferably also location of the wireless device, wherein receiving can include sensing GPS satellite signals; a WAN device that receives and transmits WAN data corresponding to the distance and preferably also location of the wireless device, wherein the WAN data comprises data from a plurality of IEEE 802 signals; an amalgamation processing unit that amalgamates the received WAN and GPS data; a segmentation processing unit that segments the amalgamated data; a distance and preferably also location accuracy processor, which can be a Wireless Area Network Location Based Services (WAN-LBS) Processing Unit that increases the distance and tracking accuracy from transmitted RF spectrum and modulation data, that optimizes transmitted RF spectrum and modulation data; an E-plane and H-plane radiation pattern determining unit that determines the azimuth and elevation of the hybrid WAN/GPS device, preferably by determining the E-plane and H-plane radiation pattern of received WAN signals from the hybrid WAN/GPS device; and a distance and location unit that applies one or more approximation algorithms to the GPS and WAN data to obtain the distance and preferably also location of the wireless device.

In yet another aspect of the present invention, a distance and preferably also location tracking device for seamless indoor and outdoor tracking of a wireless device is provided. The tracking device includes a hybrid wireless area network (WAN)/global positioning system (GPS) circuit board. The circuit board includes a GPS device that receives and transmits GPS data corresponding to the distance and preferably also location of the wireless device, wherein receiving can include sensing GPS satellite signals; a WAN device that receives and transmits WAN data corresponding to the distance and preferably also location of the wireless device, wherein receiving can include sensing WAN signals and wherein the WAN data comprises data from a plurality of IEEE 802 signals; an amalgamation processing unit that amalgamates the received WAN and GPS data; a segmentation processing unit that segments the amalgamated data; a distance and preferably also location accuracy processing unit that optimizes transmitted RF spectrum and modulation data; an E-plane and H-plane radiation pattern determining unit that determines the azimuth and elevation of the hybrid WAN/GPS device; and a distance and preferably also location unit that applies one or more approximation algorithms to the GPS and WAN data to obtain the distance and preferably also location of the wireless device.

In one aspect of the present invention, a tangible computer readable storage medium which stores a program for causing a computer to execute a method for seamless indoor and outdoor tracking of a wireless device is provided. The program includes a GPS signal receiving code segment that receives and transmits GPS data corresponding to the distance and preferably also location of the wireless device; a WAN signal receiving code segment that receives and transmits WAN data corresponding to the distance and preferably also location of the wireless device, wherein the WAN signals comprise a plurality of IEEE 802 signals; an amalgamation processing code segment that amalgamates the received WAN and GPS data; a segmentation processing code segment that segments the amalgamated data; a distance and preferably also location processor code segment that optimizes the distance and preferably also location of transmitted RF output spectrum and modulation data; an E-plane and H-plane radiation pattern determining code segment that determines the azimuth and elevation location using E-plane and H-plane radiation pattern of the hybrid WAN/GPS device; and a distance and preferably also location code segment that applies one or more approximation algorithms to the GPS and WAN data to obtain the distance and preferably also location of the wireless device.

### BRIEF DESCRIPTION OF THE DRAWINGS

The accompanying drawings, which are incorporated in and constitute a part of this specification, illustrate several embodiments of the present invention, and together with the written description, serve to explain certain principles of the present invention.

FIG. 1 depicts an exemplary system for determining the distance and position of the hybrid WAN/GPS circuit board according to one aspect of the present invention.

FIG. 2A depicts an exemplary embodiment of the present invention, in which a military vehicle is equipped with the hybrid WAN/GPS hardware (running WAN-LBS software according to the present invention) for battlespace tracking of mobile troops and mobile troops are equipped with the hybrid WAN/GPS circuit boards.

FIG. 2B depicts an exemplary embodiment of the present invention, in which a hybrid WAN/GPS handheld (running WAN-LBS software according to the present invention) is used to detect several hybrid WAN/GPS collars or bracelets; such collars or bracelets can be located and tracked seamlessly from an outdoor to indoor environment (or vice versa).

FIG. 3 depicts a block diagram of an exemplary WAN-LBS system according to the present invention that utilizes a hybrid WAN/GPS circuit board for seamless indoor and outdoor distance and location tracking.

FIG. 4 illustrates the propagation distances, data rates, subgroups, and commercial names of IEEE 802 transceivers (corresponding to IEEE 802 wireless standard protocols) included in the WAN receiver of a hybrid WAN/GPS circuit board according to an exemplary embodiment of the present invention.

FIG. 5A depicts a top-level block diagram of the Amalgamation Processing Unit performed by the hybrid WAN/GPS circuit board according to an exemplary embodiment of the present invention.

FIG. 5B depicts a top-level block diagram of microcontroller that performs the Amalgamation, and/or the Segmentation, and/or WAN-LBS Algorithm Processing Unit embedded in the hybrid WAN/GPS circuit board according to an exemplary embodiment of the present invention.

FIG. 5C illustrates an exemplary hybrid WAN/GPS circuit board silkscressen layout that is populated with electrical components and depicts the location of various top-level block diagrams from the exemplary WAN-LBS system.

FIG. 6 depicts a top-level block diagram of a Segmentation Processing Unit within the hybrid WAN/GPS circuit board according to an exemplary embodiment of the present invention.

FIG. 7 depicts a diagram showing an exemplary embodiment of the WAN-LBS algorithm, in which the azimuth and elevation location between two or more fixed and/or mobile devices is calculated based on antennae vertical polarization (and the polarization loss factor of the antenna) when the E-Plane of the antenna is not perpendicular to the other hybrid WAN/GPS circuit board.

FIG. 8 depicts exemplary method steps for determining the location of a wireless device according to another aspect of the present invention.

FIG. 9 depicts a flow diagram for WAN-LBS software modules, which are implemented in a handheld device, computer, and/or embedded in the hybrid WAN/GPS device according to an exemplary embodiment of the present invention.

### DETAILED DESCRIPTION OF VARIOUS EMBODIMENTS OF THE INVENTION

Reference will now be made in detail to various exemplary embodiments of the present invention, examples of which are illustrated in the accompanying drawings. The following detailed description is provided to supply a fuller description of certain embodiments of the present invention, and is not intended as a limiting disclosure of all embodiments of the present invention. Rather, those of skill in the art will be able to understand the full scope of the present invention after consideration of the above broad description, the following detailed description of certain embodiments, and the claims. Furthermore, the disclosure of U.S. Patent Application Publication No. 2009/0196267 is incorporated by reference in its entirety.

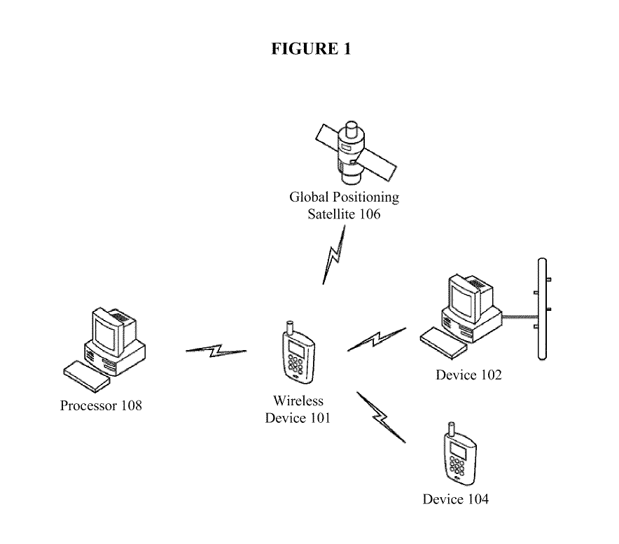

According to one aspect of the present invention, a system for seamless indoor and outdoor distance and position of a hybrid WAN/GPS circuit board is provided. FIG. 1 shows systems for determining the distance and position of an embedded hybrid WAN/GPS circuit board 101, 102, 104, and 108. The wireless device 101 may correspond to a computer, laptop, PDA, cell phone, Blackberry™, or any other wireless device with embedded IEEE 802 capabilities or equivalent capabilities. Preferably, wireless device 101 is capable of sensing WAN signals from other devices 102, 104, and 108. For example, device 102 may correspond to network access points, while devices 104 may correspond to other devices in an ad-hoc environment. Preferably, communication between the wireless device 101 and devices 102, 104 and/or 108 takes place in accordance with any of the IEEE 802 standards as disclosed, for example, in ANSI/IEEE 802 Standards, incorporated herein by reference in entirety. According to another aspect, the wireless device 101 is also capable of sensing signals from one or more Global Positioning Satellites 106. In addition, the wireless device 101 is further in communication with a processor 108 and is able to communicate received position data to the processor 108.

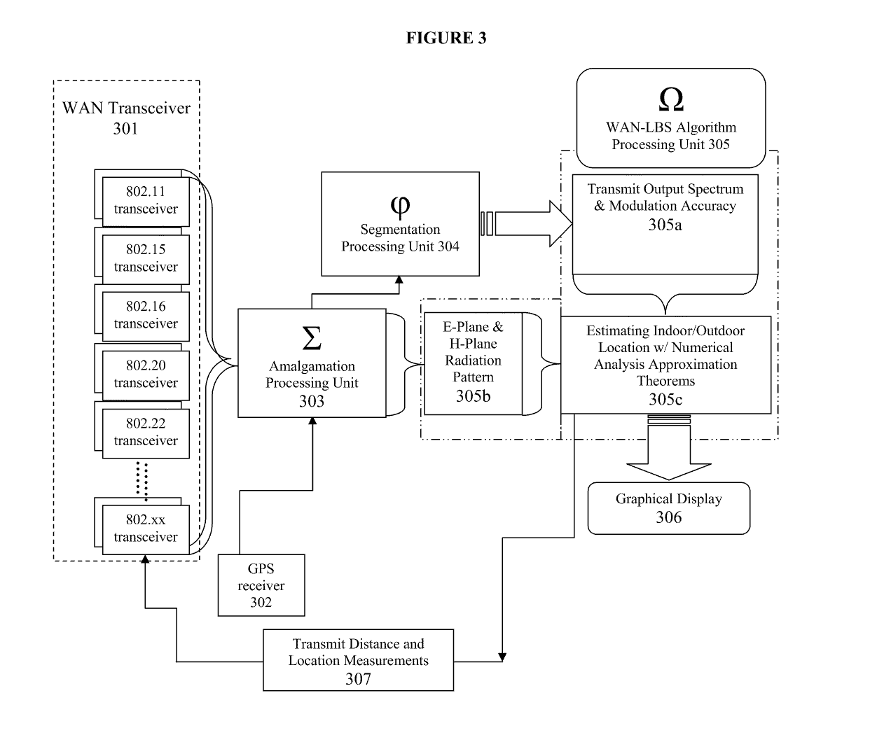

Preferably, wireless device 101 includes a hybrid WAN/GPS circuit board that comprises: a WAN card, a GPS receiver, and one or more processors (further described with respect to FIG. 3). Processor 108 (which may be connected to or integrated within the hybrid WAN/GPS device according to the present invention) is capable of iteratively receiving position data from the wireless devices 104 and/or 108, and applying one or more approximation algorithms to the distance and location data to obtain a distance and location of the hybrid WAN/GPS device.

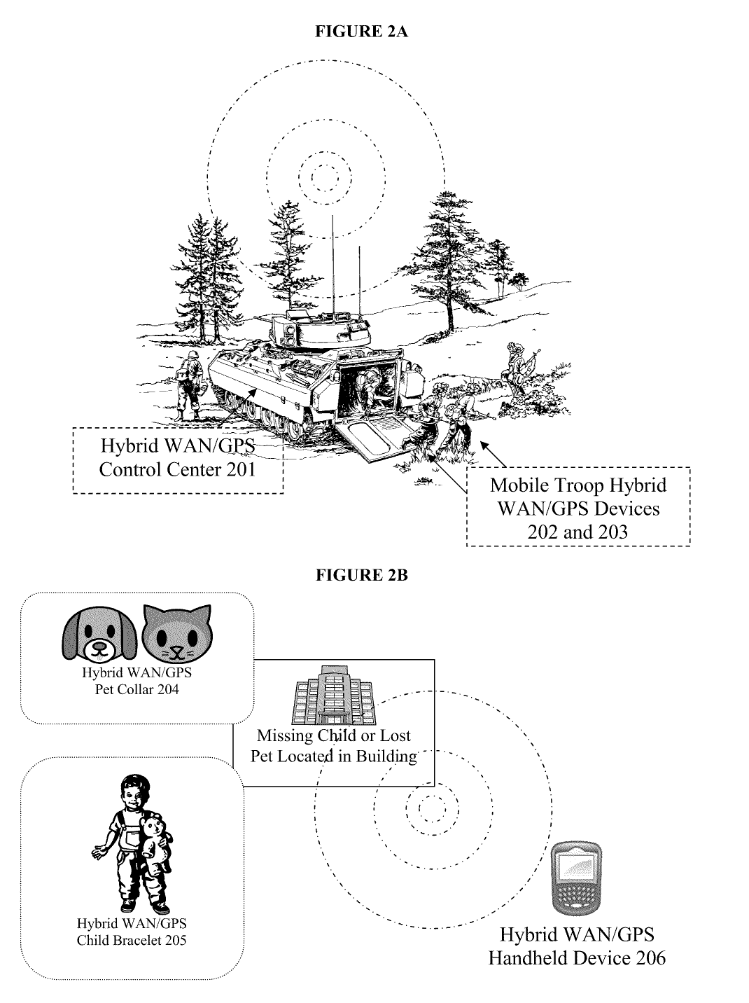

In FIG. 2A, a military vehicle is equipped with hybrid WAN/GPS control center 201 (running WAN-LBS software according to the present invention) for battlespace tracking of mobile troops and mobile troops is equipped with hybrid WAN/GPS devices 202 and 203. Hybrid WAN/GPS control center 201 and hybrid WAN/GPS devices 202 and 203 may correspond to a computer, laptop, PDA, cell phone, Blackberry™, or any other wireless device with embedded IEEE 802 capabilities or equivalent capabilities. Thus, hybrid WAN/GPS devices 202 and 203 may correspond to any wireless device with IEEE 802 capabilities within a garment, identifier tag, or any other object that can be can be attached to the user in a safe and secure manner.

This exemplary embodiment of the present invention is particularly suited to military applications in remote and/or hostile military environments. The Department of Defense (DoD) is tasked with developing and integrating Command, Control, Communications, Computers, Intelligence, and Surveillance and Reconnaissance (C4ISR) technologies that facilitate assessment of the battlespace; deny and disrupt enemy efforts; remain “connected” to achieve and sustain information superiority; and strike with decisive lethality and survive. One mission of the U.S. Army and Marines is to utilize and exploit current technology, including Non-Development Items (NDI) and Commercial Off-The-Shelf (COTS) equipment to develop wireless communications networks for Dismounted Soldiers and forward-deployed, unmanned, smart munitions, sensors and robotic systems. The Army and Marines are continually looking for new technologies that will provide the soldier with the best, most affordable technology to execute the mission. Thus, the Army has a high level of interest in wireless sensor networking technology that will provide individual soldiers with tactical network-centric capability. More specifically, the DoD has an interest in technologies such as the Location Based Services (LBS) algorithm utilizing a Hybrid IEEE 802 and Global Positioning System (GPS) device for indoor and outdoor tracking. Thus, the present invention addresses the critical need to provide wireless connectivity, situational awareness, and three dimensional (3D) distance and location tracking in the absence of a fixed communications infrastructure and employ rapid reaction solutions that will enhance the safety, survivability, security, and effectiveness of responders in a crisis.

In FIG. 2B, a hybrid WAN/GPS handheld device 206 (running WAN-LBS software according to the present invention) is used to detect several hybrid WAN/GPS collars or bracelets; such collars or bracelets can be located and tracked seamlessly from an outdoor to indoor environment (or vice versa). Therefore, the present invention addresses the critical need to provide wireless distance and location measurement of children and/or pets in weather disasters, search/rescue, and/or urban/rural environment (e.g., floods, snow blizzards). Hybrid WAN/GPS handheld device 206 and hybrid WAN/GPS pet collar 204 and child bracelet 205 may correspond to a computer, laptop, PDA, cell phone, Blackberry™, or any other wireless device with embedded IEEE 802 capabilities or equivalent capabilities. Thus, hybrid WAN/GPS pet collar 204 and child bracelet 205 may correspond to any wireless device with IEEE 802 capabilities within a garment, jewelry, or any other object that can be attached to the user in a safe and secure manner. In other words, FIG. 2B presents examples of tracking devices that are envisioned as part of the invention.

Global Positioning Systems/Global Systems for Mobile (GPS/GSM) have become the most popular way of tracking dogs and cats for middle and upper income families. However, expensive hardware and monthly fees have restricted growth in this market. In addition, GSM devices will not work without cell coverage. Therefore, there are limited options available in real-time pet tracking and no products that can track dogs and cats indoors. Thus, the hybrid WAN/GPS pet collar according to the present disclosure provides an inexpensive alternative to conventional pet tracking devices.

Furthermore, in child safety applications, it is critical to be able to quickly and effectively determine the distance and location of a missing child. More specifically, the capability to seamlessly detect a missing person both indoors and outdoors is essential to effectively determine the distance and locate a missing person. Thus, the hybrid WAN/GPS bracelet according to the present disclosure provides an effective tool for parents and first responders to track the distance and location of missing persons. In an alternative embodiment, the hybrid WAN/GPS device according to the present disclosure may be secured to goods or property to track their distance and location and facilitate the return of stolen goods or property. Of course, numerous other examples of items that can be used for tracking are encompassed by the present invention and can be immediately envisioned by those of skill in the art without the need to disclose each one specifically herein.

In FIG. 3, an exemplary WAN-LBS system according to the present disclosure utilizes a hybrid WAN/GPS circuit board for seamless indoor and outdoor tracking of distance and preferably location. The WAN-LBS algorithm works in tandem with a customized hybrid circuit board with IEEE 802 transceivers and a GPS transceiver. This customized circuit board provides raw GPS and WAN data that are fed to the Amalgamation Processing Unit 303, Segmentation Processing Unit 304, and WAN-LBS Algorithm Processing Unit 305. The WAN-LBS algorithm uses numerical analysis approximation theorems to determine precise measurements. The overall goal of numerical analysis is to implement approximation techniques for solving errors in raw data distance and location measurements due to the WAN transceiver and/or the GPS receiver. The WAN-LBS algorithm, in conjunction with the hybrid circuit board, improves the degrees of precision and accuracy in the distance and locating of a fixed or mobile IEEE 802 device.

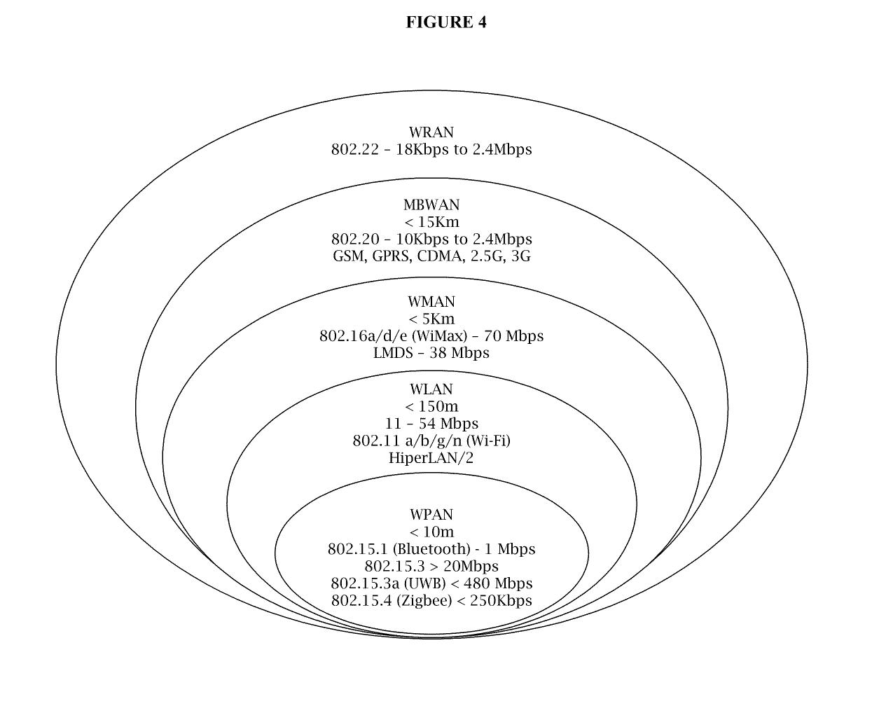

In FIG. 3, WAN transceiver 301 includes various IEEE 802 transceivers (as shown in further detail in FIG. 4). Fixed and mobile IEEE 802 devices transmit their radio frequency (RF) signal using the defined spectrum and protocol defined by the corresponding IEEE 802 standard. Thus, WAN transceiver 301 receives RF signals corresponding to various IEEE 802 transceivers, which include (but are not limited to) 802.11™ (Wi-Fi®), 802.15™ (WPAN, Bluetooth, ZigBee), 802.16™ (WiMax), 802.20™ (MBWA), and/or 802.22™ (WRAN). The WAN transceiver may also be modified to include IEEE 802 transceivers corresponding to any other IEEE 802 standard protocol that is not explicitly listed herein. Initially, the IEEE 802 devices and hybrid WAN/GPS board are sending acknowledgment messages along with common information as defined by the corresponding IEEE 802 standard. This common information is used to calculate the distance and location with a robust WAN-LBS algorithm.

The Amalgamation Processing Unit 303 of the hybrid WAN/GPS circuit board integrates the data of both GPS Receiver 302 and WAN Transceiver 301. In FIG. 3, this raw data is fed into the Segmentation Processing Unit 304, as well as the electric field intensity (E-plane) and Magnetic Field Intensity (H-plane) Radiation Pattern Determining Unit 305b of the WAN-LBS Algorithm Processing Unit 305. GPS Receiver 302 provides three dimension (3-D) position, velocity, time, and frequency data because there is a minimum of twenty-four (24) operational satellites in six (6) orbital planes, at an altitude of about 22,000 km. GPS satellites transmit a code for timing purposes, and a navigation message, which includes their exact orbital location and system integrity data. The WAN/GPS circuit board uses the data to precisely establish the satellite location. Thus, GPS Receiver 302 within the hybrid WAN/GPS circuit board determines position by measuring the time taken for these signals to arrive. At least three satellites are required to determine latitude and longitude when the altitude is known and at least a fourth satellite to obtain a 3-D fix.

For outdoor reception, GPS Receiver 302 should receive signals from at least four (4) satellite vehicles (SVs) to obtain a 3-D position fix. To measure the range from the SVs to the receiver, two criteria are required: signal transmission time and signal reception time. All GPS satellites have several atomic clocks that keep precise time and these are used to time-tag the transmission time onto the GPS signal then control the transmission sequence of the coded signal. Likewise, the WAN/GPS receiver includes an internal clock to precisely identify the arrival time of the signal.

GPS Receiver 302 outputs two (2) types of messages in ASCII strings (raw data): National Marine Electronics Associations (NMEA) and Debug messages. While, the Dilution of Precision (DOP) is a measure of the satellites' geometry thereby determining the error in measure based on the spacing between the detected satellites. The NMEA data outputs raw data formats, including (but not limited to) Geographic Position (latitude and longitude with time of position data, hereinafter “GPGLL”); Global Positioning System Fixed Data (time and position with GPS data hereinafter “GPGGA”); GNSS DOP and Active Satellites (GPS receiver in operation and DOP values, hereinafter “GPGSA”); GNSS Satellites in View (number of satellites in view, elevation, and azimuth, hereinafter “GPGSV”); Recommended Minimum Data by NMEA (hereinafter “GPRMC”); Velocity and Track over Ground (hereinafter “GPVTG”); Coordinated Universal Time (date and time, hereinafter “GPZDA”).

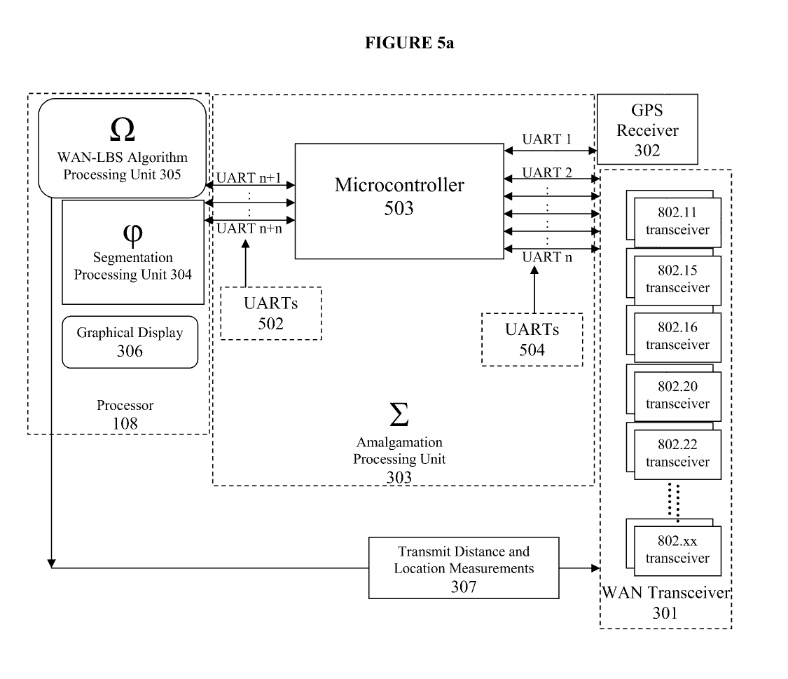

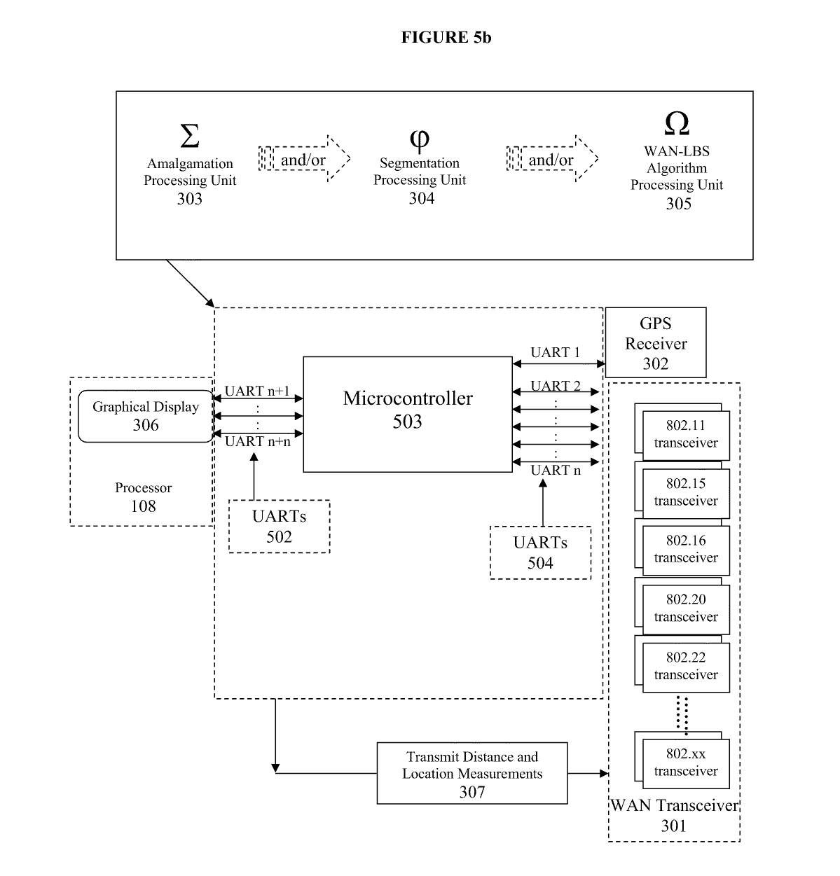

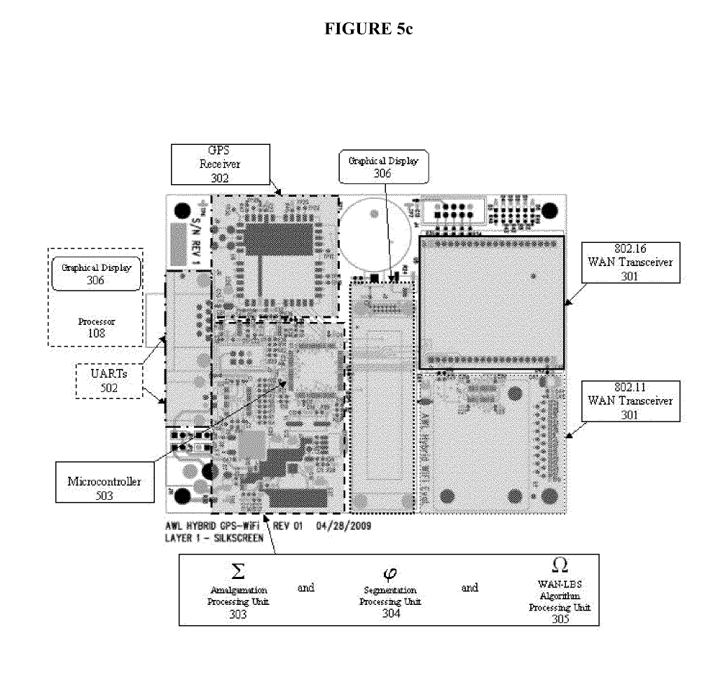

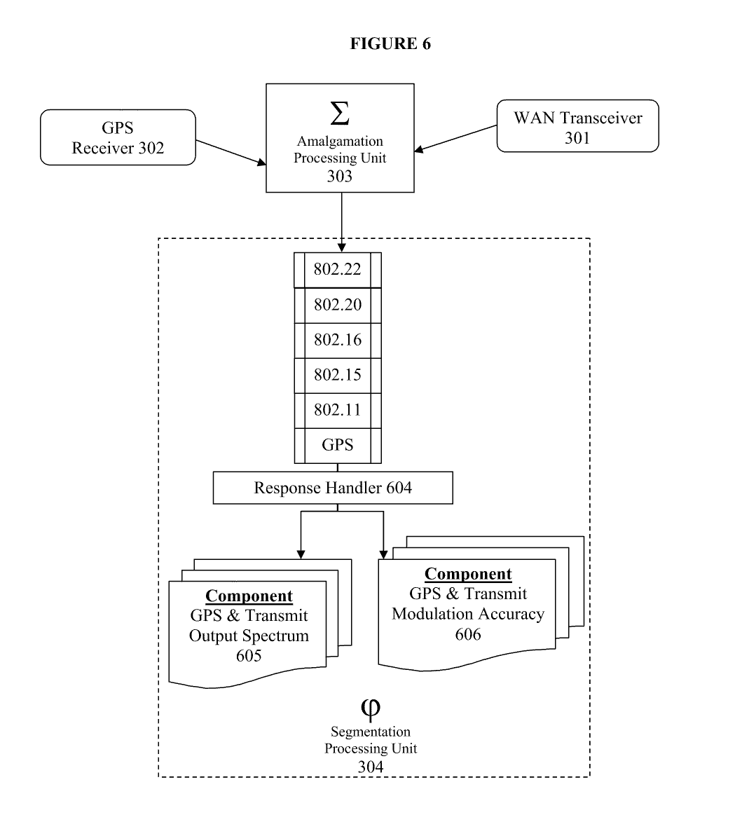

The amalgamation processing unit 303 of the hybrid circuit board integrates the data of a GPS receiver and several IEEE 802 transceivers (as shown in further detail in FIG. 5). In an outdoor location or rural environment, the GPS signal may be obtained from a constellation of 24 or more earth orbiting satellites, commercially available at 1 pulse per second (pps) with standard frequencies such as 1, 5, and 10 MHz. Because GPS signals are terrestrial receivers (radio signals received through a conventional aerial satellite), it is easy for other sources of electromagnetic radiation to desensitize the signal strength. Thus, the received signal tends to be relatively weak. This makes acquiring and tracking the satellite signals difficult or impossible within an indoor or a pre-existing infrastructure environment. Although some countries allow the use of GPS repeaters to boost indoor GPS reception; laws in European Union and the United Kingdom prohibit the use of repeaters because the signals can cause interference to other GPS receivers that may receive data from both GPS satellites. In an indoor location, the hybrid WAN/GPS circuit board according to the present disclosure toggles (or switches) to a WAN mode so that a flawless and seamless transition is maintained between indoor and outdoor tracking environments.

Likewise, the amalgamated data is required to determine the overlaying coordinates—the X, Y, and/or Z distance calculations between two or more fixed and/or mobile devices through the characteristics of the antenna pattern. The antenna field strength is leverage as a directional tracking mechanism (i.e., north, south, east, and/or west). More specially, the E-plane and H-plane radiation patterns are field intensity indicators of the main-beam and sidelobe antenna directions. This field intensity garners three antenna characteristics, which are used for overlaying coordinates: a) width of the main beam, b) sidelobe levels, and c) directivity.

The amalgamated data is transmitted to and input into segmentation processing unit 304 which divides the data into components and subcomponents via a response handler (shown in FIG. 6), so that the numerical algorithm can be applied in the next progress. The core of the segmentation process is achieved utilizing the response handler that is primarily a lexical text parser. Information received from the hybrid amalgamation block divides the string data into components and/or subcomponents, called tokens, based on punctuation and other key parameters.

As shown in FIG. 3, the WAN-LBS Algorithm Processing Unit 305 executes three key processes: 1) improving the distance and location measurements from the RF transmitted output spectrum and modulation accuracy; 2) determining the azimuth and elevation location from the E-Plane and H-Plane radiation patterns; and 3) estimating indoor/outdoor distance and location with numerical analysis approximation theorems. The WAN-LBS software algorithm improves the degrees of precision and accuracy for distance measurements in locating fixed and/or mobile IEEE 802 devices. The algorithm receives data from segmentation processing unit 304, as well as an Electric Field Intensity (E-plane) and Magnetic Field Intensity (H-plane) Radiation Pattern Determining Unit 305b. The WAN distance and location measurements are improved using two (2) components and eight (8) subcomponents defined in the IEEE protocol standard to yield overlaying coordinates, which in turn garners the location of a mobile or fixed IEEE 802 device. The data points from the various component and subcomponents are acquired to render a reasonable approximation of the distance between one or more devices through numerical analysis. In turn, the location of the mobile or fixed IEEE 802 device is output and displayed by graphical display 306 of wireless device 101, 102, and/or 104.

The distance and location tracking information is transmitted to a central command and/or to another mobile device using all or a selected group of IEEE 802® protocols 307 (e.g., Wireless Local Area Network (WLAN), Wireless Personal Area Network (WPAN), and/or Wireless Metropolitan Area Network (WMAN)). Therefore, the calculated distances and locations are distributed using wireless area networks, including (but not limited to) 802.11™ (Wi-Fi®), 802.15™ (WPAN, Bluetooth, ZigBee), 802.16™ (WiMax), 802.20™ (MBWA), and/or 802.22™ (WRAN). In exemplary embodiments of the present invention, the hybrid WAN/GPS circuit board is a palm-size tracking device and the software is compatible with Commercial Off-The-Shelf (COTS) handheld Personal Digital Assistant (PDA) and/or laptops computers.

IEEE 802 Transceiver

FIG. 4 illustrates the propagation distances, data rates, subgroups, and commercial names of IEEE 802 transceivers of WAN Receiver 301. GPS receivers experience difficulty acquiring and maintaining a coherent satellite lock when traveling in a valley, pre-existing infrastructure, in urban environments, or a hostile military environment. The GPS receiver antenna must have a clear view of the sky to acquire satellite lock. In certain environments, a complete satellite lock may be lost or only three (3) satellites tracked to compute a 2-D position fix. Also, a position fix may not be updated when inside a building or beneath a bridge, but may down grade to 2-D mode with only three (3) satellites by assuming its height remains constant. However, this assumption can lead to very large errors especially when a change in height occurs. As discussed above, WAN Transceiver 301 includes several IEEE 802 transceivers, including (but not limited to) 802.11™ (Wi-Fi®), 802.15™ (WPAN, Bluetooth, ZigBee), 802.16™ (WiMax), 802.20™ (MBWA), and/or 802.22™ (WRAN); each of these IEEE 802 transceivers (and their capabilities according to the corresponding IEEE 802 standards) are discussed in detail below. The reception of one or more IEEE 802 signals is referred hereinafter as the “WAN mode”.

IEEE 802.15 Transceiver

The Wireless Personal Area Network (WPAN) is the 15th working group of the IEEE 802 standard and is known under the Bluetooth and ZigBee certification. The 802.15 WPAN™ focuses on the development of consensus standards for Personal Area Networks or short distance wireless networks. The wireless distance is approximately ten (10) meters with a bandwidth of 1 Mbps and 480 Kbps for Bluetooth and Zigbee, respectively. These WPANs address wireless networking of portable and mobile computing devices such as PCs, Personal Digital Assistants (PDAs), peripherals, cell phones, pagers, and consumer electronics.

IEEE 802.11 Transceiver

The 802.11 standard is known under the commercial name “Wi-Fi” under the Wireless Local Area Network (WLAN) category. The segment of the radio frequency spectrum used varies between countries. In the United States, 802.11a and 802.11g devices may be operated without a license, as allowed in Part 15 of the FCC Rules and Regulations.

Frequencies used by channels one through six (802.11b) fall within the 2.4 GHz amateur radio band. Licensed amateur radio operators may operate 802.11b/g devices under Part 97 of the FCC Rules and Regulations, allowing increased power output but not commercial content or encryption. The 802.11b and 802.11g use the 2.4 GHz Industrial Scientific Medical (ISM) frequency band with a maximum physical layer bit rate of 11 Mbit/s and 54 Mbit/s, respectively. The 802.11a standard uses the same data link layer protocol and frame format as the original standard, but an OFDM based air interface (physical layer). The 802.11 standard operates in the 5 GHz band with a maximum net data rate of 54 Mbit/s.

IEEE 802.16 Transceiver

Although the IEEE 802.16 family of standards is officially called “WirelessMAN”, it has been commercialized under the name “WiMAX” (Worldwide Interoperability for Microwave Access) by the industry alliance known as the WiMAX Forum. The most popular implementation of the IEEE 802.16 standard is the Mobile WirelessMAN, originally defined as the IEEE 802.16e standard. The wireless distance is less than 5 Km at 70 Mbps.

IEEE 802.20 Transceiver

IEEE 802.20 or Mobile Broadband Wireless Access (MBWAN) is an IEEE Standard that enables worldwide deployment of multi-vendor interoperable mobile broadband wireless access networks. Specification of physical and medium access control layers of an air interface for interoperable mobile broadband wireless access systems, operating in licensed bands below 3.5 GHz, optimized for IP-data transport with peak data rates per user in excess of 1 Mbps. MBWAN supports various vehicular mobility classes up to 250 Km/h in a MAN environment and targets spectral efficiencies, sustained user data rates and numbers of active users that are all significantly higher than achieved by existing mobile systems.

IEEE 802.22 Transceiver

IEEE 802.22 is a standard for Wireless Regional Area Network (WRAN) using white spaces in the TV frequency spectrum. The development of the IEEE 802.22 WRAN standard is aimed at using cognitive radio techniques to allow sharing of geographically unused spectrum allocated to the Television Broadcast Service, on a non-interfering basis, to bring broadband access to hard-to-reach, low population density areas, typical of rural environments, and is therefore timely and has the potential for a wide applicability worldwide.

Amalgamation Processing

FIG. 5 depicts a top level block diagram of the amalgamation processing performed by the hybrid WAN/GPS circuit board and associated firmware according to an exemplary embodiment of the present disclosure. The amalgamation processing integrates the data of GPS Receiver 302 and the IEEE 802 transceivers in WAN Transceiver 301. In an indoor environment, the hybrid circuit board toggles (or switches) to a WAN mode so that a flawless and seamless transition is maintained between indoor and outdoor tracking environment. Because the logic circuitry is programmable, the amalgamation process is achieved with a microcontroller, Field-Programmable Gate Array (FPGA), and/or Digital Signal Processor (DSP) through the firmware software code.

As shown in FIGS. 5A and 5B, microcontroller 503 communicates with numerous Universal Asynchronous Receivers/Transmitters (UARTs 502 and 504). The UARTs 502 and 504 are microchips that control the microcontroller's interface to receive, send, and/or exchange data. A microcontroller is better suited to processing and recombining ASCII serial data than an FPGA or DSP. A DSP may be utilized when the application interfaces with sensors and signal process. Additionally, the IEEE 802 transceivers in WAN Transceiver 301 may be configured to send commands to microcontroller 503.

The UARTs 502 and 504 are responsible for tasks including (but not limited to) converting data bytes the UARTs receive from the IEEE 802 transceivers into a single serial bit stream for outbound transmission; on inbound transmission, converting the serial bit stream into the bytes that the WAN-LBS algorithm handles; adding a parity bit, if necessary, on outbound transmissions and checks the parity of incoming bytes, if selected, and discarding the parity bit; adding start and stop delineators on outbound and strips them from inbound transmissions; and handling interruptions from the microcontroller.

The UART connections from the microcontroller to the GPS Receiver and WAN Transceiver are made on circuit board at logic levels. Therefore, the microcontroller runs at the maximum speed allowed by the GPS receiver and WAN Transceiver. The microcontroller is well suited for the task as it can interact with serial UARTs interfaced devices and in-system reprogrammable. The GPS receiver, as well as the IEEE 802 Transceivers, have serial communication capability but are not limited to serial communication. The GPS receiver outputs NMEA data on its serial port with no intervention. Data from the GPS receiver mainly consists of coordinate data, but may also include diagnostic information such as number of locked satellites, etc. The IEEE 802 Transceivers require commands to query information, such as Basic Service Set Identification (BSSID); Service Set Identification (SSID); Medium Access Control (MAC) address; data rate; and signal strength. Once the data is received by the microcontroller, the data is combined and the microcontroller can process the data simultaneously as new data is entering the UARTs. After the amalgamation processing of the data from the GPS Receiver and WAN Transceiver is complete, the amalgamated data is forwarded to the Segmentation Processing Unit 304. Depending on the functionality of the microcontroller, the microcontroller may contain Segmentation Processing Unit 304 and/or the WAN-LBS Algorithm Processing Unit 305 and segmentation processing and/or the WAN-LBS Algorithm are performed in the microcontroller or implemented on a computer, laptop, PDA, cell phone Blackberry™, or any other wireless device (see FIGS. 5A, 5B, and 5C). In FIG. 5A, the wired connection is via UARTs 502 to the Processor 108 that then transmits the distance and location measurements 307 via WAN transceiver 301. In FIGS. 5B and 5C, the microcontroller contains the Amalgamation Processing Unit 303, Segmentation Processing Unit 304, and WAN-LBS Algorithm Processing Unit 305, and amalgamation and segmentation processing and the WAN-LBS Algorithm are performed in the Microcontroller 503. Microcontroller 503 then transmits the distance and location measurements 307 via WAN transceiver 301.

Segmentation Processing Unit

As shown in FIG. 6, Segmentation Processing Unit 304 segments the data via Response Handler 604, which is primarily a lexical text parser. The segmentation process separates the string data into components and/or subcomponents through Response Handler 604. First, the GPS data is output. Then, the IEEE 802 portion of the data repeats as necessary until all fixed and/or mobile devices are detected. Then, the GPS data proceeds to begin the cycle again. This data format allows for no limit on the number of fixed or mobile devices discovered and provides maximum accuracy in an indoor and/or outdoor environment; a seamless method of determining the distance and location of a device embedded within the hybrid WAN/GPS circuitry and/or firmware. When the segmentation processing unit is not receiving any GPS signals, the segmentation processing unit outputs the WAN data block and the GPS data block remains static. The GPS receiver will output data rather indoors or outdoors; however, the data reading will remain the same (static) if less than three satellites can be viewed by the device. Therefore, the Segmentation Processing Unit will monitor the GPS data block for changes in coordinates.

WAN-LBS Algorithm Processing Unit

As discussed above, the WAN-LBS Algorithm Processing Unit 305 executes three key processes: 1) improving the distance and location measurements from the RF transmitted output spectrum and modulation accuracy; 2) determining the azimuth and elevation location from the E-Plane and H-Plane radiation patterns; and 3) estimating indoor/outdoor distance and location with numerical analysis approximation theorems. The hybrid WAN/GPS circuit board amalgamates data from the GPS receiver and the various IEEE 802 transceivers of the WAN transceiver. The WAN-LBS software algorithm, in conjunction with the hybrid WAN/GPS circuit board, improves the degrees of precision and accuracy for distance measurements in locating fixed or mobile IEEE 802 devices. The degrees of precision and accuracy in distance and location are also improved utilizing numerical analysis approximation algorithms. At least three approximation algorithms (discussed in further detail below) are used to determine the degrees of precision and provide distance and location coordinates of a fixed or mobile device, including (but not limited to) the following approximation algorithms: Discrete Least Squares (DLS), DLS on Exponential Data, and the Cubic Spline.

Improving Transmitted Output Spectrum and Modulation Accuracy

The WAN-LBS algorithm according to the present disclosure uses two (2) components and eight (8) subcomponents defined in the Physical Layer (PHY) of the IEEE standard to yield overlaying coordinates, which in turn determine the distance and location of mobile and fixed IEEE 802 devices. The distance is calculated in the X, Y, and Z directions separately and the coordinates are combined to produce a single point in space (i.e., the overlaying coordinates). The data from the various components and subcomponents are acquired to render a reasonable approximation of the overlaying coordinates through numerical analysis. The WAN-LBS algorithm converts the components and subcomponents of the received WAN and GPS data into a 1) distance (λ), 2) position (λxyz), 3) velocity (v=dλ/dt), and/or 4) acceleration (a=dv/dt) measurement in free space. The components and subcomponents of the received WAN and GPS data are as follows:

TABLE 1
Transmit Output Spectrum

| | | | |
|---|---|---|---|
| 1. | Transmitter Power in dBm | 2. | Receiver Power in dBm |
| 3. | Average Power (in Transmitter | 4. | Output Transmit Power |
| | and Receiver) in dBm | | in dBm |
| 5. | Transmitter Spectrum Mask in | 6. | Power Density in dBm |
| | dBm vs. Frequency in GHz | | vs. Frequency in KHz |
| 7. | Complementary Cumulative | 8. | Peak Output Power |
| | Distribution Function in | | in dBm |
| | dBm vs. Probability | | |

Transmit Modulation Accuracy

| | | | |
|---|---|---|---|
| 1. | Constellation Error in dB | 2. | Error Vector Magnitude |
| | | | (EVM) |

The standard IEEE 802™ devices comprise a physical (PHY) layer that transmits and receives data through a Radio Frequency (RF) medium. The transmitter and receiver power of the IEEE 802™ device are the main factors in the fixed or mobile device RF coverage area. An increase in power will increase the RF coverage. Therefore, the transmitted output spectrum and modulation accuracy are directly or inversely proportional to the RF signal strength, RF coverage, and the distance from/to the transceiver.

Location of Hybrid 802 WAN/GPS Circuit Board Utilizing E-Plane and H-Plane Radiation Patterns

The hybrid WAN/GPS circuit board utilizes an antenna's electric and magnetic field intensity to determine the azimuth and elevation location. The term azimuth is commonly found in reference to “the horizon” or “the horizontal”, whereas the term elevation commonly refers to “the vertical”. The algorithm receives data from the Segmentation Processing Unit, as well as the electric field intensity (E-Plane) and magnetic field intensity (H-Plane) Radiation Pattern determining unit via the Amalgamation Processing Unit. The polarization loss factor is used between two or more hybrid WAN/GPS devices to determine azimuth and elevation locations.

The characteristics of the antenna pattern is utilized to provide a three-dimensional prospective of the distance between two or more devices. Antennas do not radiate uniformly in all directions in space. Therefore, the antenna field strength is leverage as a directional tracking mechanism. More specially, the E-plane pattern and H-plane radiation patterns are field intensity indicators of the main-beam and sidelobe directions. In general, an antenna is characterized by three parameters: 1) width of the main beam; 2) sidelobe levels; and 3) directivity.

The main beam width describes the sharpness of the radiation region and must be pointed in the direction where the antenna is designed to have its maximum radiation. The sidelobes are normally considered unwanted radiation. However, the sidelobe level of an antenna pattern is leverage to obtain peripheral information on the distance and location of two or more devices. The directivity of an antenna pattern is the maximum directive gain of an antenna and it is the ratio of the maximum radiation intensity to the average radiation intensity.

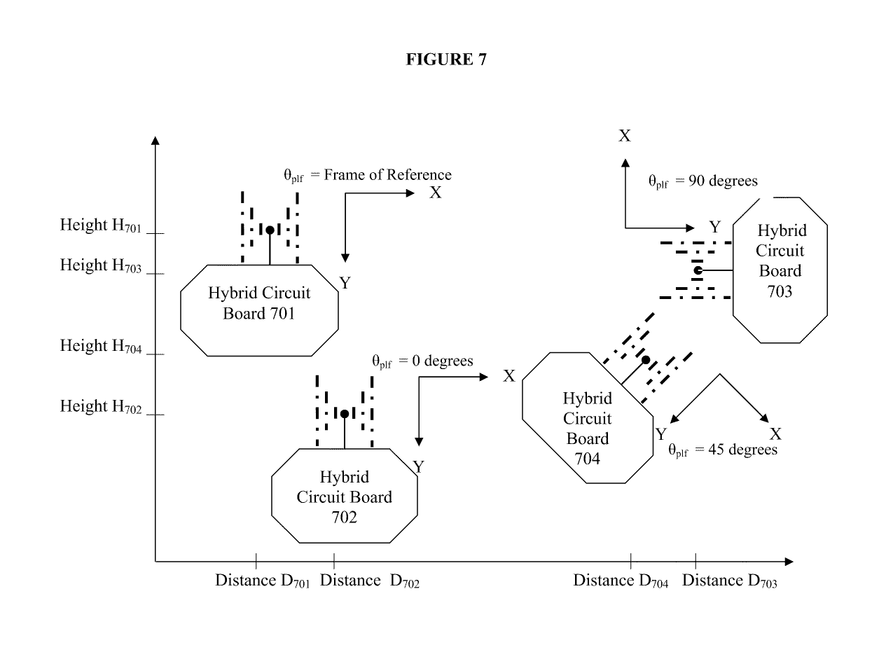

A linear polarized antenna radiates in one plane containing the direction of propagation. Thus, an antenna is vertically polarized when its electric field (E-Plane) is perpendicular to the Earth's surface. An antenna is horizontally polarized when its electric field (E-Plane) is parallel to the Earth's surface. Therefore, a horizontally polarized antenna may not communicate with a vertically polarized antenna (see FIG. 7, Hybrid WAN/GPS Circuit Board 701 and 703). A vertically polarized antenna transmits and receives vertically polarized fields (see FIG. 7, Hybrid WAN/GPS Circuit Board 701 and 702). A misalignment of polarization of 45 degrees degrades the signal up to 3 dB, and the attenuation can be 20 dB or more if the misalignment is 90 degrees (see FIG. 7, Hybrid WAN/GPS Circuit Boards 701 and 704).

When antennas of two or more hybrid WAN/GPS devices have the same polarization, the angle between their E-Planes is zero and there is very little or no power loss due to polarization mismatch. If one antenna is vertically polarized and the others are horizontally polarized, the angle is 90 degrees and very little or no power will be transferred. The maximum and minimum polarization efficiencies occur when the difference between the polarization angles of the two antennas equals 0 and 180 degrees. The polarization efficiency may be defined by following formula (1):

$$P = \frac{1 + \vert {p}^{2} \vert \vert {q}^{2} \vert + 2 \vert p \vert \vert q \vert Cos ( {Ψ}_{1} - {Ψ}_{2} )}{( 1 + {\vert p \vert}^{2} ) ( 1 + {\vert q \vert}^{2} )} \qquad ( 1 )$$

wherein
ψ₁=polarization ratio phase of the receiving hybrid WAN/GPS circuit board antenna
ψ₂=polarization ratio phase of the transmitting hybrid WAN/GPS circuit board antenna
p=complex polarization ratio of the receiving hybrid WAN/GPS circuit board
q=complex polarization ratio of the transmitting hybrid WAN/GPS circuit board

The polarization loss factor (PLF) is power loss between a vertically polarized transmitting antenna and a horizontally polarized receive antenna, which is expressed in formulas (2) and (3):

$$\begin{matrix}PLF = {\vert Cos ( {θ}_{plf} ) \vert}^{2} & ( 2 ) \\ {θ}_{plf} = {Tan}^{- 1} ( \frac{{h}_{1} - {h}_{2}}{D} ) & ( 3 )\end{matrix}$$

wherein
θ_{plf}=the angle between two antennae;
h₁=the height of the receiving hybrid WAN/GPS circuit board from the ground;
h₂=the height of the transmitting hybrid WAN/GPS circuit board from the ground; and
D=the distance between the receiving and transmitting hybrid WAN/GPS circuit board.
   Utilizing PLF, the WAN-LBS algorithm calculates a 1) distance (D), 2) position (Dxyz), 3) velocity (v=dD/dt), and/or 4) acceleration (a=dv/dt) measurement in free space.

Calculating Distance Coordinates from GPS Data

GPS coordinates are commonly displayed in angular coordinates rather than projected to a Cartesian coordinate system. The degrees of latitude and longitude measure the angle between a location and the earth's equator. Latitude and longitude are frequently recorded as degrees, minutes and seconds. Moreover, one degree of longitude is about 69 miles at the equator and 0 miles at the poles. Latitude is approximately 69 miles.

At least three satellites are required to determine latitude and longitude when the altitude is known and at least a fourth satellite to obtain a 3-D fix. The GPS outputs two (2) types of messages in ASCII strings (raw data): National Marine Electronics Associations (NMEA) and Debug messages. Using latitude and longitude values, the approximate distance is estimated on the Earth as followed (4):

\sqrt{X²+Y²} (4)

Where X=69.1 (latitude2−latitude1)
Y=53.0 (longitude2−longitude1)
This produces a 10% error in distance. The accuracy can be improved by adding a cosine function.
Where X=69.1 (latitude2−latitude1)
Y=69.1 (longitude2−longitude1)*Cosine(latitude1/57.3)

The distance is calculated between two (2) GPS coordinates by taking the difference between latitude and longitude data sets (5) and (6). The Great Circle Distance formula is an estimate that requires a spherical geometry and a high level of floating point mathematical accuracy (i.e., double precision).

λ_{GPS}=3963.0*Arcos[sin(latitude1/57.2958)*Sin(latitude2/57.2958)+Cos(latitude1/57.2958)*Cos(latitude2/57.2958)*Cos(latitude2/57.2958)−longitude1/57.2958)] (5)

or

λ_{GPS}=r*Acos[sin(latitude1)*Sin(longitude2)+Cos(latitude2)*Cos(latitude2)* Cos(longitude2−longitude1)] (6)

Where r=3963.0(normal miles)

Calculating Distance Coordinates from WAN Data

The most effective means in obtaining distance and location measurements is with dBm values because there is a direct relationship between RF signal strength and distance. It is possible to convert from one unit to another with varying degrees of accuracy. When RF energy is measured in milliwatts, the signal level is the amount of energy transmitted. The decibel milliwatt is a logarithmic measurement of signal strength, and dBm values can be converted to and from mW values. Thus, the following formula may be used for the conversion:

dBm=log(mW)*10 (7)

Thus, the inverse square law bound a RF signal and the energy level will decrease for distance greater than one wavelength away from the radiating source. The actual energy of the radiated signal will be influenced by various electrical magnetic limitations (e.g., radio interference, penetration loss, and multipath conditions).

There are four (4) units of measurements that are used to signify Radio Frequency (RF) signal strength: mW (milliwatts), dBm (db−milliwatts), RSSI (Receive Signal Strength Indicator), and a percentage measurement. There is nothing in the IEEE 802 standard that stipulates a relationship between RSSI value and mW or dBm. Vendors have chosen to provide their own levels of accuracy, granularity, and range for the actual power level. There is no specified accuracy to the RSSI reading. Herein, the measurements make use of dBm values to achieve the best distance granularity.

A number of vendors utilize the RSSI measurement to calculation distance; however, RSSI is an arbitrary integer value defined by the manufacturers. The IEEE 802 standard defines a RSSI integer with an allowable range of 0-255 which allows for extreme granularity in signal strength readings. On the other hand, there are no vendors utilizing 256 different signal levels or specify a maximum RSSI value of 256 because this level of granularity will require an increase in computer processing power. Likewise, there is a mapping between RSSI and dBm values but the conversion table must be obtained from the wireless card manufacturers. For example, Cisco chooses to measure 101 separate values for RF energy, Symbol Technology uses a maximum RSSI value of 31, and the Atheros chipset uses a maximum RSSI value of 60. This has a direct relation to the distance calculation, the degrees of precision, and its accuracy in locating a fixed or mobile IEEE 802® device. The RSSI value determines the threshold required to transmit data. Moreover, the RSSI value differs from vendor-to-vendor because different maximum RSSI values provide different distance calculations based on the chipset.

Improving WAN and GPS Distance Measurements with Numerical Analysis Approximation Theorems

With a fixed or mobile IEEE 802 device, the degrees of precision and accuracy for distance measurement are improved upon utilizing approximation algorithms. At least, three (3) approximation algorithms are used to improve the degrees of precision for distance measurements and provides WAN and GPS location coordinates: Discrete Least Squares (DLS), DLS on Exponential Data, and the Cubic Spline. As discussed above, the WAN-LBS algorithm uses two (2) components and eight (8) subcomponents defined in the physical layer of the IEEE standard to yield overlaying coordinates (the X, Y, and/or Z distance calculations), which in turn garners the distance and location of a mobile or fixed IEEE 802 device. The WAN and GPS data points from the various component and subcomponents are acquired to render a reasonable approximation of the 3 dimensional (3D) overlaying coordinates through numerical analysis.

Approximation Theorems: Discrete Least Squares (DLS)

The least squares method is the most convenient procedure for determining the best linear approximations. Likewise, the least squares approach puts substantially more weight on a point that is out of line with the rest of the data but not allow that point to completely dominate the approximation. In addition, the values obtained from a linear least squares procedure are unbiased estimates for the equation that describes the mean, if the data has their mean distributed in a linear manner. Moreover, the values obtained can be used to calculate an unbiased estimator for the variance associated with the distribution. The issue of fitting the least squares line to a collection of data involves minimizing (8):

$${\sum }_{i = 1}^{m} {[ {y}_{i} - ( {ax}_{i} + b ) ]}^{2} \qquad ( 8 )$$

Because m represents the number of samples, the coefficients of a and b are determined by following equations (9):

$$a = \frac{m ( {\sum }_{i = 1}^{m} {x}_{i} {y}_{i} ) - ( {\sum }_{i = 1}^{m} {x}_{i} ) ( {\sum }_{i = 1}^{m} {y}_{i} )}{m ( {\sum }_{i = 1}^{m} {x}_{i}^{2} ) - {( {\sum }_{i = 1}^{m} {x}_{i} )}^{2}} \& \\ b = \frac{( {\sum }_{i = 1}^{m} {x}_{i}^{2} ) ( {\sum }_{i = 1}^{m} {y}_{i} ) - ( {\sum }_{i = 1}^{m} {x}_{i} {y}_{i} ) ( {\sum }_{i = 1}^{m} {x}_{i} )}{m ( {\sum }_{i = 1}^{m} {x}_{i}^{2} ) - {( {\sum }_{i = 1}^{m} {x}_{i} )}^{2}} \qquad ( 9 )$$

Approximation Theorems: DLS on Exponential Data

Because the RF is normally measured in milliwatts (mW) or decibel milliwatts (dBm), the signal strength is not linear by nature but it is inversely proportional to the square of the distance. Moreover, the dBm values are a logarithmic measurement of signal strength. It is appropriate to assume that the data are exponentially related. This requires the approximating function to be of the form (10) or (11):

y=be^{ax} (10)

or

y=bx^{a}, (11)

for some constants a and b. Using the equations in (10) or (11), the following coefficients of a and b are determined by following equations (12):

$$a = \frac{m ( {\sum }_{i = 1}^{m} {x}_{i} ln {y}_{i} ) - ( {\sum }_{i = 1}^{m} {x}_{i} ) ( {\sum }_{i = 1}^{m} ln {y}_{i} )}{m ( {\sum }_{i = 1}^{m} {x}_{i}^{2} ) - {( {\sum }_{i = 1}^{m} {x}_{i} )}^{2}} \& \\ b = \frac{( {\sum }_{i = 1}^{m} {x}_{i}^{2} ) ( {\sum }_{i = 1}^{m} ln {y}_{i} ) - ( {\sum }_{i = 1}^{m} {x}_{i} ln {y}_{i} ) ( {\sum }_{i = 1}^{m} {x}_{i} )}{m ( {\sum }_{i = 1}^{m} {x}_{i}^{2} ) - {( {\sum }_{i = 1}^{m} {x}_{i} )}^{2}} \qquad ( 12 )$$

Approximation Theorems: Cubic Spline

This algorithm may be used for at least two (2) specific applications: a) interpolation of all WAN and GPS data received from the hybrid WAN/GPS device and b) interpolation of the transmit output spectrum and modulation data which includes the two (2) components and eight (8) subcomponents defined in the Physical Layer (PHY) of the IEEE standard. Also, the algorithm may be implemented on the components and subcomponents converted into 1) distance (λ), 2) position (λxyz), 3) velocity (v=dX/dt), and/or 4) acceleration (a=dv/dt) measurement. The Cubic Spline is expressed as a linear system described by the vector equation Ax=B, where A (13) is the (n+1) by (n+1) matrix and B (14) and x (15) are vectors. The matrix A is diagonally dominant and the linear system has a unique solution of x is c₀, c₁, . . . , cₙ.

$$\begin{matrix}A = \begin{matrix}1 & 0 & 0 & 0 & 0 & 0 & 0 & 0 \\ {h}_{0} & 2 ( {h}_{0} + {h}_{1} ) & {h}_{1} & 0 & 0 & 0 & 0 & 0 \\ 0 & {h}_{1} & 2 ( {h}_{1} + {h}_{2} ) & {h}_{2} & 0 & 0 & 0 & 0 \\ 0 & 0 & {h}_{2} & 2 ( {h}_{2} + {h}_{3} ) & {h}_{3} & 0 & 0 & 0 \\ 0 & 0 & 0 & {h}_{3} & 2 ( {h}_{3} + {h}_{4} ) & {h}_{4} & 0 & 0 \\ 0 & 0 & 0 & 0 & {h}_{4} & 2 ( {h}_{4} + {h}_{5} ) & {h}_{5} & 0 \\ 0 & 0 & 0 & 0 & 0 & {h}_{5} & 2 ( {h}_{5} + {h}_{6} ) & {h}_{6} \\ 0 & 0 & 0 & 0 & 0 & 0 & 0 & 1\end{matrix} & ( 13 ) \\ B = \begin{matrix}0 \\ \frac{3}{{h}_{1}} ( {a}_{2} - {a}_{1} ) - \frac{3}{{h}_{0}} ( {a}_{1} - {a}_{0} ) \\ \frac{3}{{h}_{2}} ( {a}_{3} - {a}_{2} ) - \frac{3}{{h}_{0}} ( {a}_{2} - {a}_{1} ) \\ \frac{3}{{h}_{3}} ( {a}_{4} - {a}_{3} ) - \frac{3}{{h}_{0}} ( {a}_{3} - {a}_{2} ) \\ \frac{3}{{h}_{4}} ( {a}_{5} - {a}_{4} ) - \frac{3}{{h}_{0}} ( {a}_{4} - {a}_{3} ) \\ \frac{3}{{h}_{5}} ( {a}_{6} - {a}_{5} ) - \frac{3}{{h}_{0}} ( {a}_{5} - {a}_{4} ) \\ \frac{3}{{h}_{6}} ( {a}_{7} - {a}_{6} ) - \frac{3}{{h}_{0}} ( {a}_{6} - {a}_{5} ) \\ 0\end{matrix} & ( 14 ) \\ X = \begin{matrix}{c}_{o} \\ {c}_{1} \\ ⋮ \\ ⋮ \\ ⋮ \\ ⋮ \\ ⋮ \\ {c}_{n}\end{matrix} & ( 15 )\end{matrix}$$

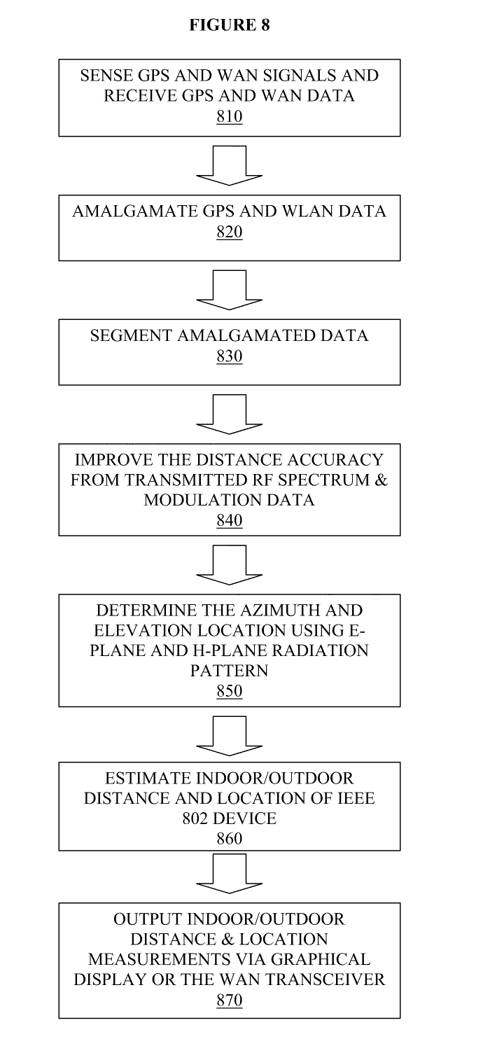

In addition to the detailed description of the hybrid WAN/GPS system provided above, FIG. 8 provides a general flow diagram of the method for determining indoor or outdoor distance and location measurements of a fixed or mobile wireless device (based on WAN and GPS data) according to the present disclosure. The method includes the steps of: sensing GPS and WAN signals and receiving GPS and WAN data using the hybrid GPS/WAN device according to the present disclosure (Step 810); amalgamating the received WAN and GPS data using the Amalgamation Processing Unit according to the present disclosure (Step 820); segmenting the amalgamated data using the Segmentation Processing Unit according to the present disclosure (Step 830); improving the distance accuracy from transmitted RF spectrum and modulation accuracy (Step 840); determining the azimuth and elevation location using E-plane and H-plane radiation pattern (Step 850); estimating indoor/outdoor distance and location using numerical analysis approximation theorems (Step 860); and displaying or outputting the indoor/outdoor distance and location of the fixed or mobile wireless device (Step 870). In embodiments, the method steps may be iteratively performed e.g., to track the position of a moving device.

WAN-LBS Software Modules

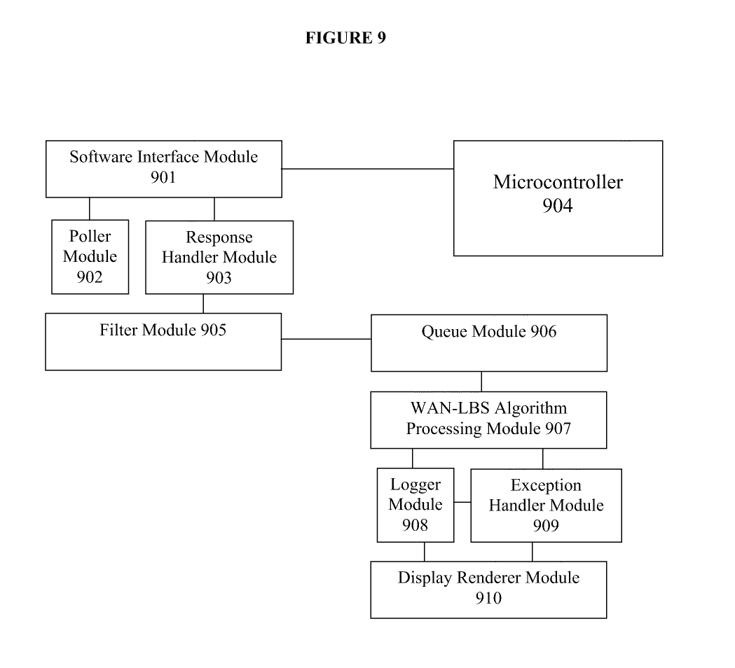

The exemplary method described above with respect to FIG. 8 may be implemented using the WAN-LBS software according to the present disclosure. In FIG. 9, the WAN-LBS software modules are depicted as Software Application Stack. The WAN-LBS software may be executed, for example, on a handheld device, laptop, computer workstation, and/or embedded in the hybrid WAN/GPS device. In the exemplary embodiment shown in FIG. 9, the WAN-LBS software includes several modules, including (but not limited to) software interface module 901, data poller module 902, response handler module 903, microcontroller 904 (corresponding to microcontroller 503, described in FIG. 5), data filter module 905, data queue module 906, WAN-LBS algorithm processing module 907, logger module 908, exception handler module 909, and display renderer module 910 (which outputs and displays the location of the mobile or fixed IEEE 802 device).

Software Interface Module

Software interface module 901 comprises of a) inputs for device information and configuration parameters and b) outputs with successful connection objects. The communication ports exchange messages that consist of blocks of data with defined formats. The message protocol specifies what type of data a message contains and how information is structured within the message. These protocols are defined by the individual WAN and GPS devices. For the GPS device, data elements are derived from the NMEA communication protocols, whereas the WAN data elements are based on the IEEE 802 standards protocols.

In an exemplary embodiment, the software interface to the hybrid WAN/GPS device may be implemented via a collection of C++ classes or equivalent which allows the communication ports (e.g., serial RS-232 and USB) on the device to be accessed. To access a communication port, the software application creates a ‘ComPort’ object, set the communication parameters, and opens a connection to that port. Special commands provide for setting various parameters of the ComPort such as the baud rate, character size, and flow control. Once the connection is opened, the host handheld device, laptop, or computer workstation performs and manages the tasks, such as a) detecting and processing received data from device and b) providing and sending data to device as needed. The ComPort is established by the logic circuitry within a microcontroller, Field-Programmable Gate Array (FPGA), and/or Digital Signal Processor (DSP).

Response Handler Module

Response Handler module 903 may comprise a) NMEA and WAN data string inputs and b) outputs tokenized NMEA and WAN data elements. The Response Handler module 903 is primarily a lexical text parser. Information received from the hybrid WAN/GPS device is divided into data strings, called tokens, based on punctuation and other keys. These data elements derived from the NMEA communication protocols and the WAN data elements derived from the IEEE 802 standards protocols.

Poller Module

Poller module 902 includes a) the connection object along with the polling rate inputs and b) outputting the successful return code. Poller module 902 issues commands to initiate device operation, i.e. polling for WAN and GPS data.

Queue Module

Queue module 906 may comprise a) tokenized NMEA and WAN data string for inputs and b) outputs queued NMEA and WAN data elements. In an exemplary embodiment, the queue module is a container where the data elements received from the hybrid WAN/GPS device are stored, and the principal operations on the collection are the addition of entities to the rear terminal position and removal of entities from the front terminal position. This makes the queue a First-In-First-Out (FIFO) data structure, i.e. a particular kind of collection in which the entities in the container are kept in order. In a FIFO data structure, the first element added to the queue will be the first one to be removed. Thus, the queue performs the function of a buffer. Specific operations to be implemented in the queue are represented in Table 2.

TABLE 2

| Operation | Description |
|---|---|
| constructors | construct a new queue |
| back | returns a reference to last element of a queue |
| empty | true if the queue has no elements |
| front | returns a reference to the first element of a queue |
| pop | removes the first element of a queue |
| push | adds an element to the end of the queue |
| size | returns the number of items in the queue |

Filter Module

Filter module 905 includes a) Queued NMEA data string inputs and b) outputting selected NMEA data element and selected WAN data elements. The selected NMEA data elements contain at least one of the following NMEA data strings: GPGLL, GPGGA, GPGSA, GPGSV, GPRMC, GPVTG, or GPZDA. The selected WAN data elements contain at least one of the following IEEE 802 standard data strings: 802.11™, 802.15™, 802.16™, 802.20™, and 802.22™.

For example, the filtering of a GPGSA data element enforces the GPS Dilution of Precision (DOP) values. All DOP measurements are packaged into the $GPGSA data element every polling period. Here is a sample of a $GPGSA data string:

$GPGSA,A,3,11,29,07,08,5,17,24,,,,,,2.3,1.2,2.0*30

The GPS receiver calculates the position using a technique called “3-D multi-lateration”, which is the process of determining where several spheres intersect. In the case of GPS, each sphere has a satellite at its center; the radius of the sphere is the calculated distance from the satellite to the GPS device. Ideally, these spheres would intersect at exactly one point, causing only one possible solution to the current location. Precision is said to be “diluted” when the area grows larger. The monitoring and control of dilution of precision (or DOP for short) is the key to writing high-precision applications.

Because of the high rate of data received by the hybrid WAN/GPS circuit board, filter module 905 may process selected GPGSA data elements. This filtering process reduces the computational overhead (or the amount of data) being forwarded to the WAN-LBS algorithm. The same process occurs for selected WAN data elements.

WAN-LBS Algorithm Module

WAN-LBS algorithm module 907 includes a) selected NMEA and selected WAN data string inputs and b) outputs 1) distance (λ), 2) position (λxyz), 3) velocity (v=dX/dt), and/or 4) acceleration (a=dv/dt) measurement. As discussed above, the WAN-LBS algorithm performs three major processes: 1) improving transmitted output spectrum and modulation accuracy, 2) determining E-Plane and H-Plane radiation pattern, and c) estimating indoor/outdoor location with numerical analysis approximation theorems. For polled location samples which have successfully passed filter module 905 and have been placed on the Queue, the output calculation may be performed on the respective selected data elements.

Exception Handler Module

Exception Handler module 909 includes a) error or exception conditions at the inputs and b) outputting error codes or messages. The module utilizes C++ exception handling system. An exception is a situation in which a program has an unexpected circumstance that the section of code containing the problem is not explicitly designed to handle. For each of the WAN-LBS modules, error handling code is embedded to capture these circumstances.

Logger Module

Logger module 908 includes a) error codes or messages for inputs and b) outputting a log file which is updated each time an input is received. Logger module 908 is a fully functional logging subsystem which is enabled during program operation and tracks specific results of the program for each of the WAN-LBS modules. All results and program exceptions are recorded in a text log file and each log file entry will be time stamped.

In embodiments, portions of the disclosure are implemented by way of computer software. The software may be implemented by one or more devices, such as wireless device 101 and processor 108. The computer software may be any set of instructions that can be understood and implemented by a computer and thus take the form of one or more computer programs and/or file sets. The software can be written in any computer language, and can be provided in any form, such as in the form of source code, object code, computer code, flow diagrams, or any other means by which those in the art convey information for implementation by way of computers. In general, the software of the present invention comprises instructions for implementing the methods of the present invention. The software may comprise all of the instructions in a single file or program, or the instructions may be separated into multiple files or programs, which when executed in conjunction with each other, execute the method of the present invention.

Those of skill in the art will immediately realize that the present invention may be provided entirely as hardware, entirely as software, or as a combination of software and hardware. It should also be apparent that the present invention may be provided as a computer program product on a computer-readable storage medium, such as that having a computer-readable program.

The present invention has been described at times above with reference to block diagrams and flowcharts. It is to be understood that each block of the block diagrams and flowcharts can be implemented by computer program instructions (i.e., software), which may be comprises on a general purpose computer or processor, special purpose computer or processor, or other programmable data processing apparatus to produce a machine or device. Execution of the instructions on the machine or device provides a means for implementing functions depicted in the diagrams and/or flowcharts.

It will be apparent to those skilled in the art that various modifications and variations can be made in the practice of the present invention and construction of devices and systems of the invention without departing from the scope or spirit of the present invention. Other embodiments of the present invention will be apparent to those skilled in the art from consideration of the specification and practice of the present invention. It is intended that the specification and examples be considered as exemplary only, with a true scope and spirit of the present invention being indicated by the following claims.

1. A method for seamless indoor and outdoor distance and location tracking of a wireless device using a hybrid wireless area network (WAN)/global positioning system (GPS) device, the method comprising:
receiving GPS and WAN data corresponding to the distance and location of the wireless device;
transmitting GPS and WAN data corresponding to the distance and location of the wireless device;
amalgamating the received WAN and GPS data;
segmenting the amalgamated data;
optimizing distance and location measurements from transmitted RF spectrum and modulation data;
determining azimuth and elevation location using E-plane and H-plane radiation pattern of the hybrid WAN/GPS device;
applying one or more approximation algorithms to the GPS and WAN data to obtain the distance and location of the wireless device; and
outputting the distance and location of the wireless device.

2. The method of claim 1, wherein the received WAN signals comprise a plurality of IEEE 802 signals.

3. The method of claim 1, wherein the one or more approximation algorithms correspond to one or more of: Discrete Least Squares (DLS), Discrete Least Squares (DLS) on Exponential Data, or Cubic Spline.

4. The method of claim 1, wherein the method steps are iteratively performed.

5. The method of claim 1, further comprising transmitting the distance and location of the wireless device to a central command unit or another mobile device via a plurality of IEEE 802® protocols.

6. A system for seamless indoor and outdoor distance and location tracking of a wireless device, the system comprising: the wireless device and/or a hybrid wireless area network (WAN)/global positioning system (GPS) circuit board, the circuit board comprising:
a GPS device that receives and transmits GPS data corresponding to the distance and location of the wireless device;
a WAN device that receives and transmits WAN data corresponding to the distance and location of the wireless device, wherein the WAN data comprises data from a plurality of IEEE 802 signals;
an amalgamation processing unit that amalgamates the received WAN and GPS data;
a segmentation processing unit that segments the amalgamated data;
a distance and location accuracy processor that optimizes transmitted RF spectrum and modulation data;
an E-plane and H-plane radiation pattern determining unit that determines the azimuth and elevation of the hybrid WAN/GPS device; and
a distance and location unit that applies one or more approximation algorithms to the GPS and WAN data to obtain the distance and location of the wireless device.

7. The system of claim 6, further comprising a display unit that outputs the distance and location of the wireless device.

8. The system of claim 6, wherein the circuit board further comprising a microcontroller, Field-Programmable Gate Array (FPGA), and/or Digtial Signal Processor (DSP) that receives data GPS data and WAN data based on received signal strength.

9. The system of claim 6, wherein the one or more approximation algorithms correspond to one or more of: Discrete Least Squares (DLS), Discrete Least Squares (DLS) on Exponential Data, or Cubic Spline.

10. The system of claim 6, wherein the circuit board transmits the distance and location to a central command unit or another mobile device via a plurality of IEEE 802® protocols.

11. A distance and location tracking device for seamless indoor and outdoor tracking of a wireless device, the tracking device comprising a hybrid wireless area network (WAN)/global positioning system (GPS) circuit board, the circuit board comprising:
a GPS device that receives and transmits GPS data corresponding to the distance and location of the wireless device;
a WAN device that receives and transmits WAN data corresponding to the distance and location of the wireless device, wherein the WAN data comprises data from a plurality of IEEE 802 signals;
an amalgamation processing unit that amalgamates the received WAN and GPS data;
a segmentation processing unit that segments the amalgamated data;
a distance and location accuracy processing unit that optimizes transmitted RF spectrum and modulation data;
an E-plane and H-plane radiation pattern determining unit that determines the azimuth and elevation of the hybrid WAN/GPS device; and
a distance and location unit that applies one or more approximation algorithms to the GPS and WAN data to obtain the distance and location of the wireless device.

12. The distance and location tracking device of claim 11, further comprising a display unit that outputs the distance and location of the wireless device.

13. The distance and location tracking device of claim 11, wherein the circuit board further comprising a microcontroller, Field-Programmable Gate Array (FPGA), and/or Digtial Signal Processor (DSP) that receives data GPS data and WAN data based on received signal strength.

14. The distance and location tracking device of claim 11, wherein the one or more approximation algorithms correspond to one or more of: Discrete Least Squares (DLS), Discrete Least Squares (DLS) on Exponential Data, or Cubic Spline.

15. The distance and location tracking device of claim 11, wherein the tracking devices transmits the distance and location to a central command unit or another mobile device via a plurality of IEEE 802® protocols.

16. A tangible computer readable storage medium which stores a program for causing a computer to execute a method for seamless indoor and outdoor tracking of a wireless device, the program comprising:
a GPS signal receiving code segment that receives and transmits GPS data corresponding to the distance and location of the wireless device;
a WAN signal receiving code segment that receives and transmits WAN data corresponding to the distance and location of the wireless device, wherein the WAN signals comprise a plurality of IEEE 802 signals;
an amalgamation processing code segment that amalgamates the received WAN and GPS data;
a segmentation processing code segment that segments the amalgamated data;
a distance and location processor code segment that optimizes distance and location of transmitted RF output spectrum and modulation data;
an E-plane and H-plane radiation pattern determining code segment that determines the azimuth and elevation location using E-plane and H-plane radiation pattern of the hybrid WAN/GPS device; and
a distance and location code segment that applies one or more approximation algorithms to the GPS and WAN data to obtain the distance and location of the wireless device.

17. The tangible computer readable storage medium of claim 16, the program further comprising a display code segment that outputs the distance and location of the wireless device.

18. The tangible computer readable storage medium of claim 16, the program further comprising a switching code segment that switches between GPS signal data and WAN signal data based on received signal strength.

19. The tangible computer readable storage medium of claim 16, the program further comprising a microcontroller, Field-Programmable Gate Array (FPGA), and/or Digtial Signal Processor (DSP) code segment that that receives data GPS data and WAN data based on received signal strength.

20. The tangible computer readable storage medium of claim 16, wherein the one or more approximation algorithms correspond to one or more of: Discrete Least Squares (DLS), Discrete Least Squares (DLS) on Exponential Data, or Cubic Spline.
